(19) United States
(12) Patent Application Publication
(10) Pub. No.: US 2007/0042130 A1
(43) Pub. Date: Feb. 22, 2007

(54) Method of treating films using UV-generated active species

(75) Inventor: Steve G. Ghanayem, Los Altos, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/346,389

(22) Filed: Feb. 1, 2006

Related U.S. Application Data
(60) Provisional application No. 60/708,957, filed on Aug. 17, 2005.

(51) Int. Cl. B05D 3/00

(52) U.S. Cl. 427/561; 427/532

(57) ABSTRACT

Methods for treating films using UV-generated radicals, ionized species, or species in an excited state are provided. The UV-generated radicals, ionized species, or species in an excited state may be generated in a remote source connected to a chamber. The radicals, ionized species, or species in an excited state are introduced into the chamber, and a film in the chamber is treated with the radicals, ionized species, or species in an excited state. Material from the radicals, ionized species, or species in an excited state may be incorporated into the film. Alternatively, or additionally, one or more properties of the film may be modified by the exposure of the film to the UV-generated radicals, ionized species, or species in an excited state.

### CROSS-REFERENCE TO RELATED APPLICATIONS

This application claims benefit of U.S. Provisional Patent Application Ser. No. 60/708,957, filed Aug. 17, 2005, which is herein incorporated by reference.

### BACKGROUND OF THE INVENTION

1. Field of the Invention

Embodiments of the present invention generally relate to methods of treating films for semiconductor substrates. More particularly, embodiments of the invention relate to methods of treating films with remotely generated active species.

2. Description of the Related Art

Semiconductor devices are typically formed by depositing and patterning different films or layers of materials on an underlying substrate. Generally, one or more of the layers is formed by providing an initial material layer including a first material that may include one or more elements or compounds, and then treating the initial material layer such that the initial material layer is modified. For example, a second material, such as atoms of another element, may be incorporated into the initial material layer to form a final material layer. For example, doped polysilicon layers may be formed by exposing a polysilicon layer that is already part of a substrate structure to a dopant gas, such as a phosphorus or boron-containing gas.

One currently used method for treating a previously deposited film to incorporate a second material includes generating radicals from a precursor comprising the second material and exposing the film to the radicals such that the second material is incorporated into the film. Methods of generating the radicals in situ, i.e., in the same processing chamber in which the recipient film is located, and methods of generating the radicals remotely, i.e., outside of the chamber in which the recipient film is located, have been developed. For example, radicals can be generated in situ or remotely using RF power or microwave power.

However, there remains a need for new methods of generating radicals or other active species to treat films of semiconductor devices.

### SUMMARY OF THE INVENTION

Embodiments of the present invention generally provide a method of treating a film in chamber using UV-generated radicals, ionized species, or species in an excited state that are generated remotely from the chamber. The UV-generated radicals, ionized species, or species in an excited state are generated in a remote source connected to the chamber and are then introduced into the chamber. The UV-generated radicals, ionized species, or species in an excited state may be oxygen, fluorine, or nitrogen. A film on a substrate in the chamber is then treated with the radicals, ionized species, or species in an excited state. Material from the radicals, ionized species, or species in an excited state may be incorporated into the film. Alternatively, or additionally, one or more properties of the film may be modified by the exposure of the film to the UV-generated radicals, ionized species, or species in an excited state.

In one embodiment, oxygen radicals, ionized oxygen species, or oxygen species in an excited state are generated using UV radiation in a remote source and are introduced into a chamber connected to the remote source. A film on a substrate in the chamber is then exposed to the oxygen radicals, ionized oxygen species, or oxygen species in an excited state.

In another embodiment, fluorine radicals, ionized fluorine species, or fluorine species in an excited state are generated using UV radiation in a remote source and are introduced into a chamber connected to the remote source. A film on a substrate in the chamber is then exposed to the fluorine radicals, ionized fluorine species, or fluorine species in an excited state.

In a further embodiment, nitrogen radicals, ionized nitrogen species, or nitrogen species in an excited state are generated using UV radiation in a remote source and are introduced into a chamber connected to the remote source. A film on a substrate in the chamber is then exposed to the nitrogen radicals, ionized nitrogen species, or nitrogen species in an excited state.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart summarizing an embodiment of a method of treating a film using UV-generated active species.

FIG. 2 is a flow chart summarizing another embodiment of a method of treating a film using UV-generated active species.

FIG. 3 is a flow chart summarizing another embodiment of a method of treating a film using UV-generated active species.

FIG. 4 is a flow chart summarizing a method of forming a nitrided high dielectric constant film according to an embodiment of the invention.

FIG. 5 is a flow chart summarizing a method of forming a nitrided high dielectric constant film according to another embodiment of the invention.

### DETAILED DESCRIPTION

Embodiments of the invention provide a method for treating a film using UV-generated radicals, ionized species, or species in an excited state. For simplicity, embodiments of the specification will be further described with respect to UV-generated active species. As defined herein, “UV-generated active species” are UV-generated radicals, UV-generated ionized species, or species in an excited state that have been excited by UV.

Treating a film with the UV-generated active species may include incorporating material from the UV-generated active species into the film. Alternatively, treating the film with the UV-generated active species may include modifying the film's properties without incorporating material into the film. For example, the film may be treated with UV-generated active species to densify the film, such as by removing material from the film, or to etch or clean the film.

The UV-generated active species may be formed by exposing to UV radiation any precursor that is capable of generating the desired active species for treating a film. For example, the precursors may comprise or consist of nitrogen, oxygen, or fluorine. However, other active species and precursors may be used.

Examples of nitrogen-containing precursors that may be used include nitrogen gas (N₂), ammonia (NH₃), hydrazines, amines, anilines, azides, and combinations thereof. Examples of oxygen-containing precursors that may be used include oxygen (O₂), ozone (O₃), nitrous oxide (N₂O), carbon monoxide (CO), carbon dioxide (CO₂), water (H₂O), and combinations thereof. Examples of fluorine-containing precursors that may be used include NF₃, F₂, CF₄, SF₆, C₂F₆, CCl₄, C₂Cl₆, and combinations thereof.

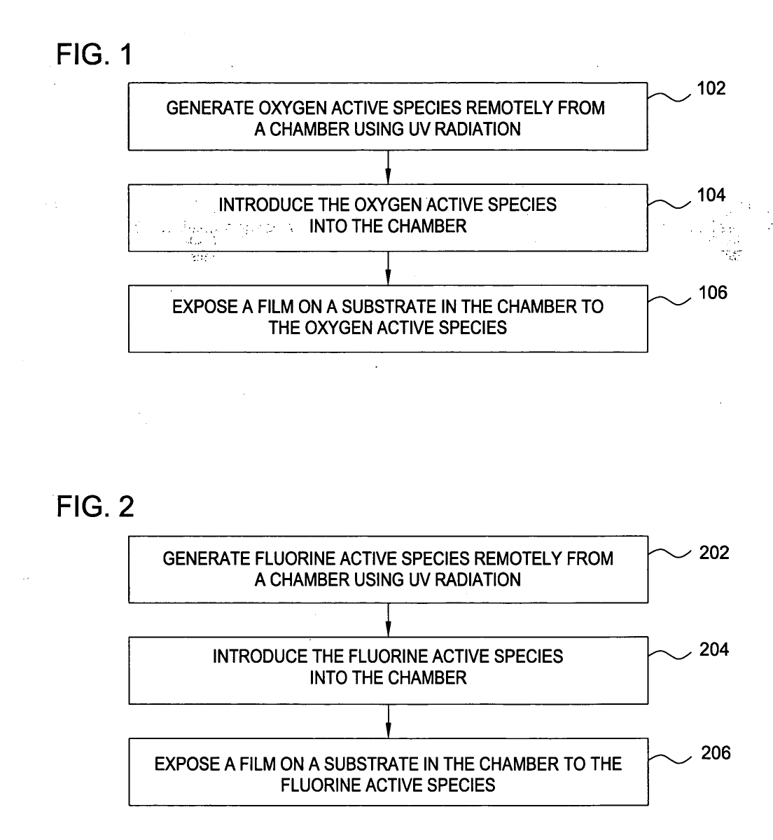

FIG. 1 is a flow chart summarizing one embodiment of a method of treating a film using UV-generated active species. UV-generated oxygen active species are generated in a remote source by UV radiation, as shown in step 102. The active species from the remote source are then introduced into a chamber in which a film of a substrate is to be treated with the active species, as shown in step 104. The film is then exposed to the UV-generated oxygen active species, as shown in step 106. Exposing the film to the UV-generated oxygen active species may modify one or more properties of the film, e.g., film density, and/or incorporate material from the UV-generated oxygen active species, e.g., to oxidize the film.

FIG. 2 is a flow chart summarizing another embodiment of a method of treating a film using UV-generated active species. UV-generated fluorine active species are generated in a remote source by UV radiation, as shown in step 202. The active species from the remote source are then introduced into a chamber in which a film of a substrate is to be treated with the active species, as shown in step 204. The film is then exposed to the UV-generated fluorine active species, as shown in step 206. Exposing the film to the UV-generated fluorine active species may modify one or more properties of the film, e.g., film density, and/or incorporate material from the UV-generated fluorine active species, e.g., to fluorinate the film.

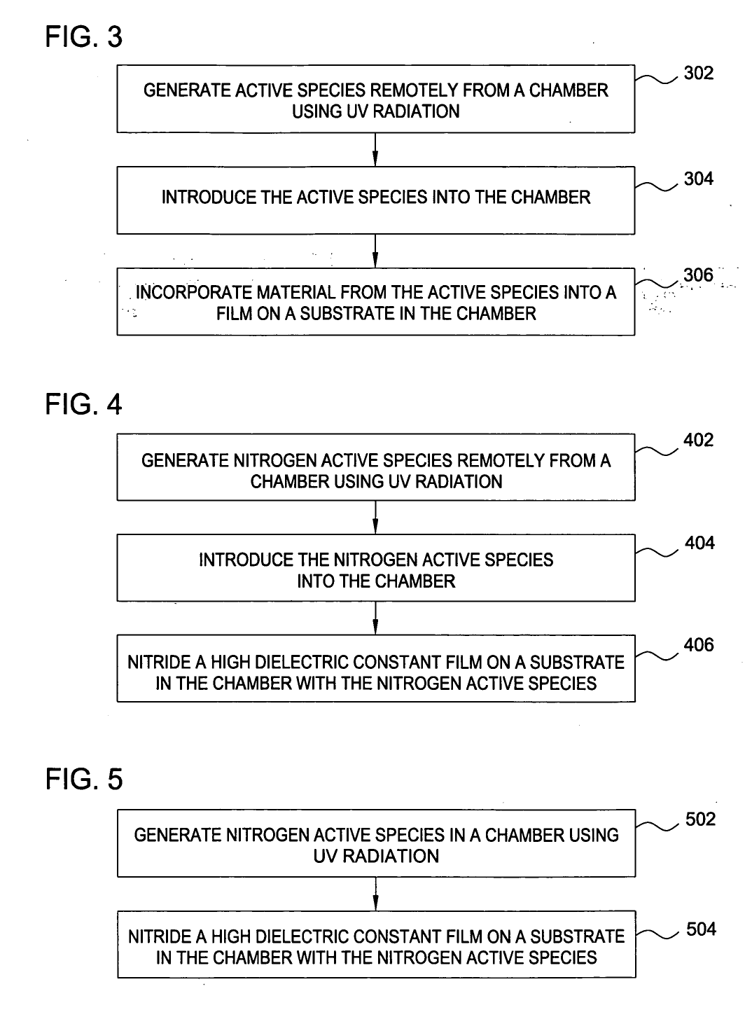

Another embodiment of a method of treating a film using UV-generated active species is illustrated in the flow chart of FIG. 3. The UV-generated active species are generated in a remote source by UV radiation, as shown in step 302. The active species from the remote source are then introduced into a chamber in which a film of a substrate is to be treated with the active species, as shown in step 304. Material from the active species is incorporated into a film of the substrate in the chamber, as shown in step 306. Generally, the film is exposed to the active species for a period of time sufficient to incorporate material from the active species throughout the entire thickness of the film. The UV-generated active species may be generated from a nitrogen-containing precursor to incorporate nitrogen into a film, i.e., nitride a film. The UV-generated active species may be generated from an oxygen-containing precursor to incorporate oxygen into a film, i.e., oxidize a film. The UV-generated active species may be generated from a fluorine-containing precursor to incorporate fluorine into a film, i.e., fluorinate a film. Films that may be treated according to embodiments of the invention include insulating or dielectric films (including low dielectric constant and high dielectric constant films), conductive films, and semiconductive films.

In any of the embodiments provided herein, the source of UV radiation for generating the active species remotely may be any UV source such as a UV lamp or UV light emitting diode array. For example, mercury microwave arc lamps, pulsed xenon flash lamps or high-efficiency UV light emitting diode arrays may be used. The source of UV radiation may include UV lamp bulbs that are sealed plasma bulbs filled with one or more gases such as xenon (Xe) or mercury (Hg) for excitation by a power source. The power source may be a microwave generator that can include one or more magnetrons and one or more transformers to energize filaments of the magnetrons. In another embodiment, the UV lamp bulbs can include an electrode or filament therein that is connected to a current supply, such as direct current (DC) or pulsed DC, that provides current to the electrode.

The power source can include radio frequency (RF) energy sources that are capable of excitation of the gases within the UV lamp bulbs. The configuration of the RF excitation in the bulb can be capacitive or inductive. An inductively coupled plasma (ICP) bulb can be used to efficiently increase bulb brilliancy by generation of denser plasma than with a capacitively coupled discharge.

Preferably, the bulbs emit light across a broad band of wavelengths from 170 nm to 400 nm. The gases selected for use within the bulbs can determine the wavelengths emitted.

The chamber in which the film is treated according to embodiments of the invention with the UV-generated active species may be any type of processing chamber to which the remote source of UV-generated active species may be connected. For example, the chamber may be a deposition chamber, e.g., an atomic layer deposition (ALD) chamber or a chemical vapor deposition (CVD) chamber, or a thermal processing chamber, e.g., a rapid thermal processing chamber.

Further details of an exemplary process according to the embodiment summarized in FIG. 3 will be provided below with respect to FIG. 4. In the embodiment of FIG. 4, the film to be treated is a high dielectric constant film, and the UV-generated active species are nitrogen active species. Nitrogen active species are generated remotely from a chamber using UV radiation, as shown in step 402. The substrate having a high dielectric constant film thereon is enclosed in the chamber. The nitrogen active species are then introduced into the chamber, as shown in step 404, and the high dielectric constant film is nitrided with the nitrogen active species, as shown in step 406. Details of the embodiment summarized in FIG. 4 will be provided below.

FIG. 5 is a flow chart summarizing another embodiment of a method of treating a film using UV-generated active species. In the embodiment of FIG. 5, the film to be treated is a high dielectric constant film, and the UV-generated active species are nitrogen active species. Nitrogen active species are generated in a chamber using UV radiation, as shown in step 502. The substrate having a high dielectric constant film thereon is enclosed in the chamber. The high dielectric constant film is nitrided with the nitrogen active species, as shown in step 504. Details of the embodiment summarized in FIG. 5 will be provided below.

While specific embodiments of the invention are described primarily with respect to treating high dielectric constant films, other materials may be treated according to embodiments of the invention. However, the development and treatment of high dielectric constant films has been of increasing importance with the continuous shrinkage of semiconductor device geometry. Since capacitance is directly proportional to the dielectric constant of a material and inversely proportional to the thickness of the material, the thinner dielectric layers used in today's shrinking devices must have a higher dielectric constant to provide sufficient dielectric capacitance. Thus, while silicon oxide, which has a dielectric constant, k, of about 3.9, has been used as a dielectric layer, such as for gate insulating layers, materials with higher dielectric constants, e.g., hafnium oxides, zirconium oxides, and tantalum oxides, are now being pursued.

Methods have been developed to deposit high dielectric constant films that are suitable for semiconductor devices. However, the high dielectric constant films may contain impurities and voids which reduce the effectiveness and durability of the films. The films may be annealed at a high temperature to force these inclusions out. The annealing process and/or other subsequent high temperature processing steps, however, can cause the films to crystallize, with the crystal structure including grains of various alignments. The boundaries between these grains provide a pathway for electrons to leak through the dielectric films and for dopants or conductor atoms to diffuse into the dielectric films. High current leakage has been observed in annealed hafnium oxide films, for example. In order to maintain structural stability, it has been shown that exposing hafnium oxide films to nitrogen in a direct plasma process, such as a decoupled plasma nitridation (DPN), can at least partially stabilize and prevent crystallization of the films. However, with DPN it is difficult to stabilize the sides and interior of the films. It has been observed that the nitrogen incorporation into the film occurs primarily at the surface of the film rather than throughout the entire thickness of the film. Thus, a process is needed to effectively stabilize the morphological structure of high dielectric constant films.

Referring again to FIGS. 4 and 5, the high dielectric film to be treated according to embodiments of the invention may be a hafnium oxide film that is deposited by a vapor deposition process, such as atomic layer deposition (ALD), chemical vapor deposition (CVD), physical vapor deposition (PVD), or combinations thereof.

In a preferred embodiment, the hafnium oxide film is deposited by ALD. “Atomic layer deposition” or “cyclical deposition” as used herein refers to the sequential introduction of two or more reactive compounds to deposit a layer of material on a substrate surface. The two, three or more reactive compounds may alternatively be introduced into a reaction zone of a processing chamber. Usually, each reactive compound is separated by a time delay to allow each compound to adhere and/or react on the substrate surface. In one aspect, a first precursor or compound A is pulsed into the reaction zone followed by a first time delay. Next, a second precursor or compound B is pulsed into the reaction zone followed by a second delay. During each time delay, a purge gas, such as nitrogen, is introduced into the processing chamber to purge the reaction zone or otherwise remove any residual reactive compound or by-products from the reaction zone. Alternatively, the purge gas may flow continuously throughout the deposition process so that only the purge gas flows during the time delay between pulses of reactive compounds. The reactive compounds are alternatively pulsed until a desired film or film thickness is formed on the substrate surface. In either scenario, the ALD process of pulsing compound A, purge gas, pulsing compound B, and purge gas is a cycle. A cycle can start with either compound A or compound B and continue the respective order of the cycle until achieving a film with the desired thickness.

One method of depositing a hafnium oxide film on a substrate by ALD includes sequentially exposing the substrate to a hafnium precursor and an oxidizing gas. The ALD process may be conducted in a process chamber at a pressure in the range from about 1 Torr to about 100 Torr, preferably from about 1 Torr to about 20 Torr, and more preferably in a range from about 1 Torr to about 10 Torr. The temperature of the substrate is usually maintained in the range from about 70° C. to about 1,000° C., preferably from about 100° C. to about 650° C., and more preferably from about 250° C. to about 500° C. A further disclosure of an ALD deposition process is described in commonly assigned U.S. patent application Ser. No. 11/127,767, filed May 12, 2005, entitled, “Apparatuses and Methods for Atomic Layer Deposition of Hafnium-containing High-K Materials,” which is incorporated herein by reference in its entirety for the purpose of describing methods and apparatus used during ALD processes.

In one example, the hafnium precursor is introduced into the process chamber at a rate in the range from about 5 sccm to about 200 sccm. The hafnium precursor is usually introduced with a carrier gas, such as nitrogen, with a total flow rate in the range from about 50 sccm to about 1,000 sccm. The hafnium precursor may be pulsed into the process chamber at a rate in a range from about 0.1 seconds to about 10 seconds, depending on the particular process conditions, hafnium precursor, or desired composition of the deposited hafnium oxide material. In one embodiment, the hafnium precursor is pulsed into the process chamber at a rate in a range from about 1 second to about 5 seconds, for example, about 3 seconds. In another embodiment, the hafnium precursor is pulsed into the process chamber at a rate in a range from about 0.1 seconds to about 1 second, for example, about 0.5 seconds. In one example, the hafnium precursor is preferably hafnium tetrachloride (HfCl₄). In another example, the hafnium precursor is preferably a tetrakis(dialkylamino)hafnium compound, such as tetrakis(diethylamino)hafnium ((Et₂N)₄Hf or TDEAH).

The hafnium precursor is generally dispensed into a process chamber by introducing a carrier gas through an ampoule containing the hafnium precursor. An ampoule may include a bubbler, a cartridge or other container used for containing or dispersing chemical precursors. A suitable ampoule, such as the PROE-VAP™, is available from Advanced Technology Materials, Inc., located in Danbury, Conn. In one example, the ampoule contains HfCl₄ at a temperature in a range from about 150° C. to about 200° C. In another example, the ampoule may contain a liquid precursor (e.g., TDEAH, TDMAH, TDMAS or Tris-DMAS) and be part of a liquid delivery system containing injector valve system used to vaporize the liquid precursor with a heated carrier gas. Generally, the ampoule may be pressurized at a pressure within a range from about 138 kPa (about 20 psi) to about 414 kPa (about 60 psi) and may be heated to a temperature of about 100° C. or less, preferably within a range from about 20° C. to about 60° C.

The oxidizing gas may be introduced to the process chamber with a flow rate in the range from about 0.05 sccm to about 1,000 sccm, preferably in the range from about 0.5 sccm to about 100 sccm. The oxidizing gas is pulsed into the process chamber at a rate in a range from about 0.05 seconds to about 10 seconds, preferably, from about 0.08 seconds to about 3 seconds, and more preferably, from about 0.1 seconds to about 2 seconds. In one embodiment, the oxidizing gas is pulsed at a rate in a range from about 1 second to about 5 seconds, for example, about 1.7 seconds. In another embodiment, the oxidizing gas is pulsed at a rate in a range from about 0.1 seconds to about 3 seconds, for example, about 0.5 seconds.

The oxidizing gas may be produced from a water vapor generator (WVG) system in fluid communication with the process chamber. The WVG system generates ultra-high purity water vapor by means of a catalytic reaction of an oxygen source gas (e.g., O₂) and a hydrogen source gas (e.g., H₂) at a low temperature (e.g., <500° C.). The hydrogen and oxygen source gases each flow into the WVG system at a flow rate within the range from about 5 sccm to about 200 sccm, preferably, from about 10 sccm to about 100 sccm. Generally, the flow rates of the oxygen and hydrogen source gases are independently adjusted to have a presence of oxygen or an oxygen source gas and an absence of the hydrogen or hydrogen source gas within the outflow of the oxidizing gas.

An oxygen source gas for generating an oxidizing gas containing water vapor may include oxygen (O₂), atomic oxygen (O), ozone (O₃), nitrous oxide (N₂O), nitric oxide (NO), nitrogen dioxide (NO₂), dinitrogen pentoxide (N₂O₅), hydrogen peroxide (H₂O₂), derivatives thereof, or combinations thereof. A hydrogen source gas useful to generate an oxidizing gas containing water vapor may include hydrogen (H₂), atomic hydrogen (H), forming gas (N₂/H₂), ammonia (NH₃), hydrocarbons (e.g., CH₄), alcohols (e.g., CH₃OH), derivatives thereof or combinations thereof. A carrier gas may be co-flowed with either the oxygen source gas or the hydrogen source gas and may include N₂, He, Ar or combinations thereof. Preferably, the oxygen source gas is oxygen or nitrous oxide and the hydrogen source gas is hydrogen or a forming gas, such as 5 vol % of hydrogen in nitrogen.

The pulses of a purge gas or carrier gas, preferably argon or nitrogen, are sequentially introduced into the process chamber after each pulse of hafnium precursor, oxidizing gas or other precursor during the ALD cycle. The pulses of purge gas or carrier gas are typically introduced at a flow rate in a range from about 2 standard liters per minute (slm) to about 22 slm, preferably about 10 slm. Each processing cycle occurs for a time period in a range from about 0.01 seconds to about 20 seconds. In one example, the process cycle lasts about 10 seconds. In another example, the process cycle lasts about 2 seconds. Longer processing steps lasting about 10 seconds deposit excellent hafnium oxide films, but reduce the throughput. The specific purge gas flow rates and duration of process cycles are obtained through experimentation. In one example, a 300 mm diameter wafer requires about twice the flow rate for the same duration as a 200 mm diameter wafer in order to maintain similar throughput.

In some of the embodiments described herein for depositing materials, an alternative oxidizing gas, such as a traditional oxidant, may be used instead of the oxidizing gas containing water vapor formed from a WVG system. The alternative oxidizing gas is introduced into the process chamber from an oxygen source containing water not derived from a WVG system, oxygen (O₂), ozone (O₃) atomic-oxygen (O), hydrogen peroxide (H₂O₂), nitrous oxide (N₂O), nitric oxide (NO), dinitrogen pentoxide (N₂O₅), nitrogen dioxide (NO₂), derivatives thereof, or combinations thereof.

Exemplary hafnium precursors include hafnium compounds containing ligands such as halides, alkylaminos, cyclopentadienyls, alkyls, alkoxides, derivatives thereof or combinations thereof. Hafnium halide compounds useful as hafnium precursors may include HfCl₄, Hfl₄, and HfBr₄. Hafnium alkylamino compounds useful as hafnium precursors include (RR′N)₄Hf, where R or R′ are independently hydrogen, methyl, ethyl, propyl or butyl. Other exemplary hafnium precursors include (Et₂N)₄Hf, (Me₂N)₄Hf, (MeEtN)₄Hf, (^{t}BuC₅H₄)₂HfCl₂, (C₅H₅)₂HfCl₂, (EtC₅H₄)₂HfCl₂, (Me₅C₅)₂HfCl₂, (Me₅C₅)HfCl₃, (ⁱPrC₅H₄)₂HfCl₂, (ⁱPrC₅H₄)HfCl₃, (^{t}BuC₅H₄)₂HfMe₂, (acac)₄Hf, (hfac)₄Hf, (tfac)₄Hf, (thd)₄Hf, (NO₃)₄Hf, (^{t}BuO)₄Hf, (ⁱPrO)₄Hf, (EtO)₄Hf, (MeO)₄Hf or derivatives thereof. Preferably, hafnium precursors used during the deposition process herein include HfCl₄, (Et₂N)₄Hf or (Me₂N)₄Hf.

While the processing conditions described above are provided with respect to depositing a hafnium oxide film in a single wafer chamber by ALD, the hafnium oxide film may be deposited in a multi-wafer chamber, such as a multi-wafer CVD chamber or a multi-wafer ALD chamber. While the same precursors may be used for single wafer chambers and multi-wafer chambers, it is recognized that the processing conditions, such as flow rates, power levels, and pulse times should be adjusted accordingly for deposition processes in multi-wafer chambers.

After the hafnium oxide film is deposited according to any of the embodiments described herein, the hafnium oxide film may be nitrided by exposing the film on a substrate in a chamber to nitrogen active species that are generated remotely from the chamber, as described in the embodiment of the invention summarized in FIG. 4. The chamber has a remote source of nitrogen active species attached thereto. The nitrogen active species are generated remotely in the remote source by UV radiation, such as with a UV lamp, and then introduced into the chamber. The nitrogen active species may be generated from a nitrogen-containing precursor such as nitrogen gas (N₂), ammonia (NH₃), hydrazines (e.g., N₂H₄ or MeN₂H₃), amines (e.g., Me₃N, Me₂NH or MeNH₂), anilines (e.g., C₆H₅NH₂), azides (e.g., MeN₃ or Me₃SiN₃), or combinations thereof. The hafnium oxide film is nitrided for a period of time sufficient to incorporate nitrogen throughout the entire thickness of the film.

While the hafnium oxide film may be nitrided by exposing the film on a substrate in a chamber to nitrogen active species that are generated remotely from the chamber, alternatively, or additionally, the hafnium oxide film may be nitrided by exposing the film on the substrate to nitrogen active species that are generated in the chamber by UV radiation, as discussed above with respect to FIG. 5. The nitrogen active species are generated by introducing a nitrogen-containing precursor such as nitrogen gas (N₂), ammonia (NH₃), hydrazines (e.g., N₂H₄ or MeN₂H₃), amines (e.g., Me₃N, Me₂NH or MeNH₂), anilines (e.g., C₆H₅NH₂), azides (e.g., MeN₃ or Me₃SiN₃), or combinations thereof into the chamber and then exposing the nitrogen-containing precursor to UV radiation, such as UV radiation provided by a UV source that is in the chamber or adjacent to a region of the chamber that is transparent to UV radiation, such as a quartz window in a lid or sidewall of the chamber.

The chamber in which the hafnium oxide film is nitrided may be the same chamber in which the hafnium oxide film is deposited or a different chamber. For example, the hafnium oxide film may be deposited in one chamber of an integrated semiconductor processing system and then transferred to another chamber of the integrated semiconductor processing system for nitridation. Examples of types of chambers that may be used to nitride the hafnium oxide layer include ALD chambers, CVD chambers, and rapid thermal processing (RTP) chambers.

While the foregoing is directed to embodiments of the present invention, other and further embodiments of the invention may be devised without departing from the basic scope thereof, and the scope thereof is determined by the claims that follow.

What is claimed is:

1. A method of treating a film on a substrate in a chamber, comprising:
generating radicals, ionized species, or species in an excited state using UV radiation in a remote source;
introducing the radicals, ionized species, or species in an excited state into a chamber connected to the remote source; and
incorporating material from the radicals, ionized species, or species in an excited state into a film on a substrate in the chamber.

2. The method of claim 1, wherein the film is selected from the group consisting of low dielectric constant films, high dielectric constant films, conductive films, and semiconductive films.

3. The method of claim 1, wherein the material from the radicals, ionized species, or species in an excited state is nitrogen, oxygen, or fluorine.

4. The method of claim 1, wherein the radicals, ionized species, or species in an excited state are generated using UV radiation provided by a UV lamp.

5. The method of claim 1, wherein the radicals, ionized species, or species in an excited state are generated using UV radiation provided by a UV light emitting diode array.

6. The method of claim 1, wherein the film is exposed to the radicals, ionized species, or species in an excited state for a period of time sufficient to incorporate the material from the radicals, ionized species, or species in an excited state throughout the entire thickness of the film.

7. The method of claim 1, wherein the chamber is selected from the group consisting of an atomic layer deposition chamber, a chemical vapor deposition chamber, or a thermal processing chamber.

8. The method of claim 1, wherein the film is a hafnium oxide film and the material from the radicals, ionized species, or species in an excited state is nitrogen.

9. The method of claim 8, wherein the radicals, ionized species, or species in an excited state are generated from a nitrogen source selected from the group consisting of nitrogen gas (N₂), ammonia (NH₃), hydrazines, amines, anilines, azides, and combinations thereof.

10. The method of claim 8, wherein the hafnium oxide film is exposed to nitrogen for a period of time sufficient to incorporate nitrogen throughout the entire thickness of the film.

11. A method of treating a film on a substrate in a chamber, comprising:
generating oxygen radicals, ionized oxygen species, or oxygen species in an excited state using UV radiation in a remote source;
introducing the oxygen radicals, ionized oxygen species, or oxygen species in an excited state into a chamber connected to the remote source; and
exposing a film on a substrate in the chamber to the oxygen radicals, ionized oxygen species, or oxygen species in an excited state.

12. The method of claim 11, wherein the oxygen radicals, ionized oxygen species, or oxygen species in an excited state are generated from an oxygen-containing precursor selected from the group consisting of oxygen (O₂), ozone (O₃), nitrous oxide (N₂O), carbon monoxide (CO), carbon dioxide (CO₂), water (H₂P), and combinations thereof.

13. The method of claim 11, wherein exposing the film to the oxygen radicals, ionized oxygen species, or oxygen species in an excited state modifies one or more properties of the film.

14. The method of claim 11, wherein oxygen from the oxygen radicals, ionized oxygen species, or oxygen species in an excited state is incorporated into the film.

15. The method of claim 14, wherein the oxygen is incorporated throughout the entire thickness of the film.

16. A method of treating a film on a substrate in a chamber, comprising:
generating fluorine radicals, ionized fluorine species, or fluorine species in an excited state using UV radiation in a remote source;
introducing the fluorine radicals, ionized fluorine species, or fluorine species in an excited state into a chamber connected to the remote source; and
exposing a film on a substrate in the chamber to the fluorine radicals, ionized fluorine species, or fluorine species in an excited state.

17. The method of claim 16, wherein the fluorine radicals, ionized fluorine species, or fluorine species in an excited state are generated from a fluorine-containing precursor selected from the group consisting of NF₃, F₂, CF₄, SF₆, C₂F₆, CCl₄, C₂Cl₆, and combinations thereof.

18. The method of claim 16, wherein exposing the film to the fluorine radicals, ionized fluorine species, or fluorine species in an excited state modifies one or more properties of the film.

19. The method of claim 16, wherein fluorine from the fluorine radicals, ionized fluorine species, or fluorine species in an excited state is incorporated into the film.

20. The method of claim 19, wherein the film is exposed to the fluorine for a period of time sufficient to incorporate the fluorine throughout the entire thickness of the film.
